(19) United States
(12) Patent Application Publication
(10) Pub. No.: US 2010/0257223 A1
(43) Pub. Date: Oct. 7, 2010

(54) Method and System For Changing A Subscription To A Tuple Based On A Changed State Of A Subscribing Principal

(76) Inventor: Robert P. Morris, Raleigh, NC (US)

Correspondence Address: SCENERA RESEARCH, LLC, 5400 Trinity Road, Suite 303, Raleigh, NC, 27607, US

(21) Appl. No.: 12/417,369

(22) Filed: Apr. 2, 2009

(51) Int. Cl. G06F 15/16

(52) U.S. Cl. 709/202

(57) ABSTRACT

Methods, systems and computer program products are described for changing a state of a subscription to a tuple. In one aspect, a principal monitor component is configured to detect a tuple state change in a first principal's tuple information from a previous state to a current state, the previous state and the current state each indicating that the first principal is actively subscribed to a tuple of a second principal, and a subscription state manager component is configured to identify an association between the detected tuple state change and subscription state information, and to determine a next state of an active subscription to the tuple of the second principal based on the subscription state information. The system also includes a subscription manager component configured to provide for changing a first state of the active subscription to the tuple of the second principal to the determined next state.

### CROSS-REFERENCE TO RELATED APPLICATIONS

This application is related to U.S. patent application Ser. No. ______, filed concurrently herewith and entitled, “Method And System For Changing A Subscription To A Tuple Based On A Changed State Of The Tuple,” the disclosure of which is incorporated herein by reference in its entirety.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

One mode of exchanging information over the Internet uses a publish/subscribe (pub/sub), asynchronous, communication protocol. The commands of an asynchronous protocol, such as a pub/sub communication protocol, are structured such that there need not be a one-to-one correspondence between messages exchanged between communication entities. In some cases a publisher of information via the protocol need not wait for, nor expect, a response from a receiver of a message. Moreover, a receiver need not send a request for each message received. That is, a receiver may receive multiple messages associated with a sent message and/or may receive an unsolicited message. Thus, unlike a request/response, synchronous protocol where the response is sent directly (synchronously) and only in response to the entity's request, the information can instead be sent to a receiver in the absence of a corresponding request from the receiver (i.e., asynchronous to any request for information).

According to pub/sub communication protocols, a pub/sub service can receive published information from a publisher and asynchronously deliver such information to receivers. Typically, the pub/sub service stores and organizes such information in a data entity known as a tuple, which in its broadest sense, is a data object containing one or more tuple elements into which information is organized and stored. The information stored in a tuple represents a principal, which can represent a user, a group, an application, an entity, or a device, that owns the tuple. Each tuple can be identified by a tuple identifier (ID), e.g., a uniform resource identifier (URI) or uniform resource locator (URL), and the principal can publish information to its associated tuple using the tuple ID.

An entity interested in receiving information published by a principal can subscribe to the principal's associated tuple by providing the tuple ID. When the principal publishes updated information identifying the tuple to be created or updated, the pub/sub service updates the tuple information and transmits the updated information to all interested entities, i.e., subscribers, via notification messages. The published information can be read simultaneously by any number of subscribers. So long as the subscriber remains subscribed to the tuple, the subscriber can continue to receive notification messages corresponding to the tuple principal's postings. Some pub/sub services can support filters that restrict the set of subscribers to whom updated information is transmitted. Subscribers can be principals.

Notably, as is used herein, the term “publish/subscribe” or “pub/sub” refers to the class of services and associated protocols where a subscribing client knows the tuple identifier, and thus the principal, of the tuple for which a subscription is to be established. Similarly, the publishing client knows the tuple identifier of the tuple to which it is publishing information, and can specify to which watching principals the tuple information should be sent, e.g., in a directed Publish or Notify. The subscriber receives only the most recently published information in a notification message resulting from a subscription. That is, the pub/sub service transmits to the subscriber only the most current state of the published information in response to new and/or updated tuple information.

In contrast to other services, the pub/sub services as described herein are not topic, class, or content based subscription services, which are typically included in message-oriented middleware (MOM) subscription services. Topic, class, and content based subscription systems are referred to in this document as MOM subscription services. In MOM subscription services, sometimes also referred to as pub/sub services, publishers do not publish to identified tuples, nor do subscribers subscribe to tuples of identified principals. Publishers and subscribers can be anonymous. Depending on the variant of this type of service, publishers publish information to nowhere in particular allowing the service to examine the content of the information, and distribute it to subscribers based on content filters included in their subscriptions to an identified topic, an identified class, and/or an identified type. More particularly, MOM subscription services do not send their messages to specific receivers, but instead characterize messages by topic, class, or content without knowledge of what (if any) subscribers there may be. Subscribers express interest in a topic, class, or content, and only receive messages that are of interest, without knowledge of what (if any) publishers there are. While sometimes referred to as pub/sub services, such MOM subscription services do not fall within the scope of the pub/sub services described herein.

As mentioned above, existing pub/sub services allow a principal interested in receiving information published by another principal to subscribe to the other principal's associated tuple. Typically, the subscription to the other principal's tuple is static, i.e., does not change, until the subscribing principal explicitly changes the subscription and/or terminates its session with the pub/sub service. In some cases, it would be desirable to alter the subscription to the other principal's tuple in response to a change in the subscribing principal's tuple information. For example, the subscribing principal can be interested in changing its subscription to the other principal's tuple automatically when the subscribing principal's communication status changes. In these cases, existing pub/sub services are not capable of changing a state of a subscription to a tuple.

### SUMMARY

Methods, systems and computer program products are described for changing a state of a subscription to a tuple. The methods, systems, and computer program products provide a means for changing a state of a principal's subscription to a tuple based on a change to the subscribing principal's tuple information. In one aspect, a system for changing a state of a subscription to a tuple comprises system components including a principal monitor component configured to detect a tuple state change in a first principal's tuple information from a previous state to a current state. The previous state and the current state each indicate that the first principal is actively subscribed to a tuple of a second principal. A subscription state manager component is configured to identify an association between the detected tuple state change and subscription state information, where the subscription state information is based on at least one of the previous state and the current state. The subscription state manager component is also configured to determine a next state of an active subscription to the tuple of the second principal based on the subscription state information. The system also includes a subscription manager component configured to provide for changing a first state of the active subscription to the tuple of the second principal to the determined next state.

In another aspect of the subject matter disclosed herein, a method and a computer readable medium storing a computer program, executable by a machine, for changing a state of a subscription to a tuple includes executable instructions for detecting a tuple state change in a first principal's tuple information from a previous state to a current state, the previous state and the current state each indicating that the first principal is actively subscribed to a tuple of a second principal, identifying an association between the detected tuple state change and subscription state information, wherein the subscription state information is based on at least one of the previous state and the current state, and determining a next state of an active subscription to the tuple of the second principal based on the subscription state information. The method also includes providing for changing a first state of the active subscription to the tuple of the second principal to the determined next state.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for changing a state of a subscription to a tuple according to an exemplary embodiment;

FIG. 3 is a block diagram illustrating a system for changing a state of a subscription to a tuple according to an exemplary embodiment;

FIG. 4 is a block diagram illustrating another system for changing a state of a subscription to a tuple according to another exemplary embodiment;

FIG. 5 is a block diagram illustrating another system for changing a state of a subscription to a tuple according to another exemplary embodiment;

FIG. 6 is a block diagram illustrating another system for changing a state of a subscription to a tuple according to another exemplary embodiment;

FIG. 7 illustrates a network in which a system for changing a state of a subscription to a tuple can be implemented; and

FIG. 8A and FIG. 8B illustrate exemplary client displays according to an embodiment.

### DETAILED DESCRIPTION

The subject matter presented herein provides for changing a state of a subscription to a tuple based on a tuple state change in a subscribing principal's tuple information. According to an embodiment, when a tuple state change in the subscribing principal's tuple information is detected, an association between the detected tuple state change and subscription state information can be identified. The identified subscription state information can be based on a previous state and/or a current state of the subscribing principal's tuple information, and indicates a next state of the subscription to the tuple of another principal. When the next state of the subscription is determined based on the identified subscription state information, the subscription to the tuple is changed from a current state to the next state.

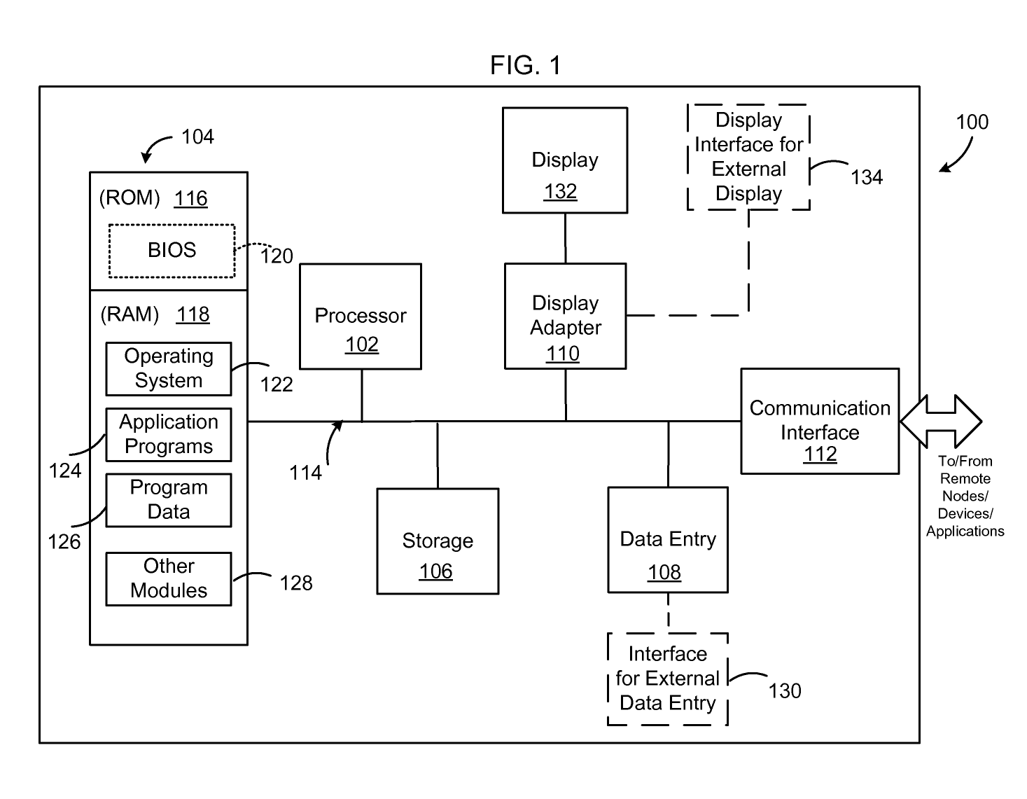

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

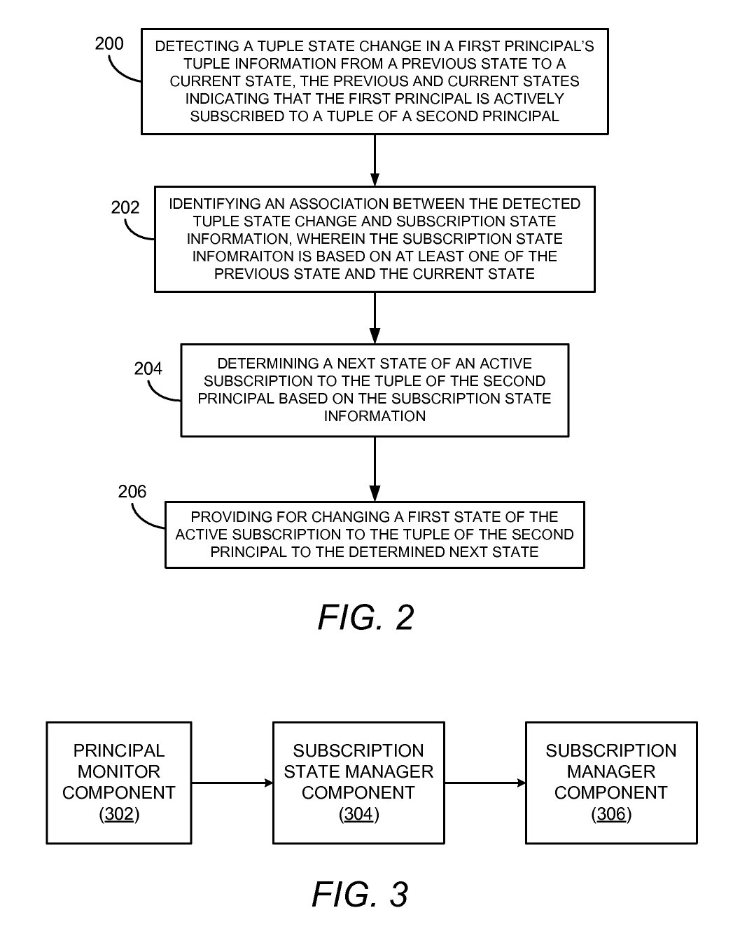

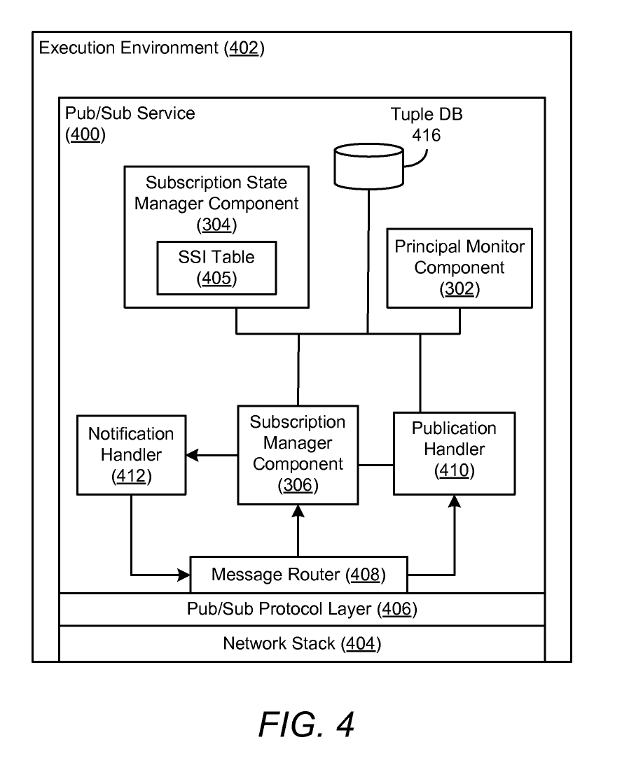

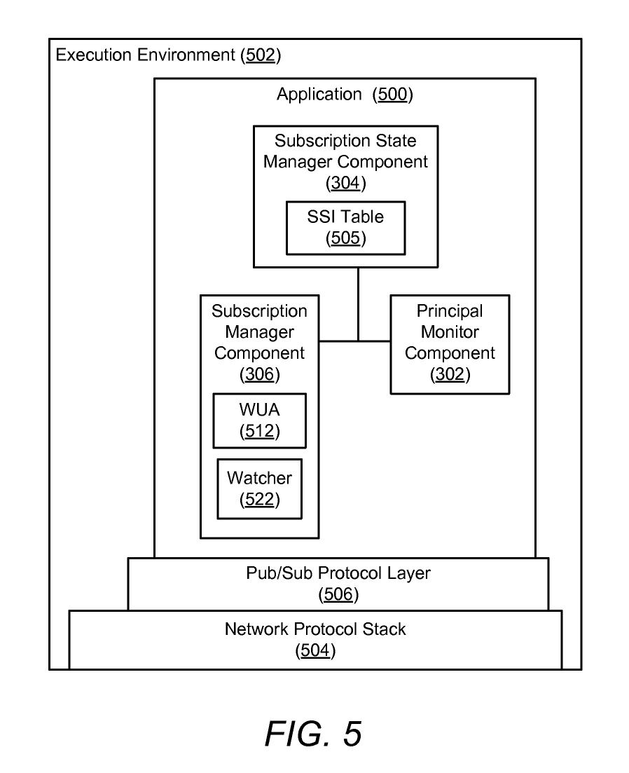

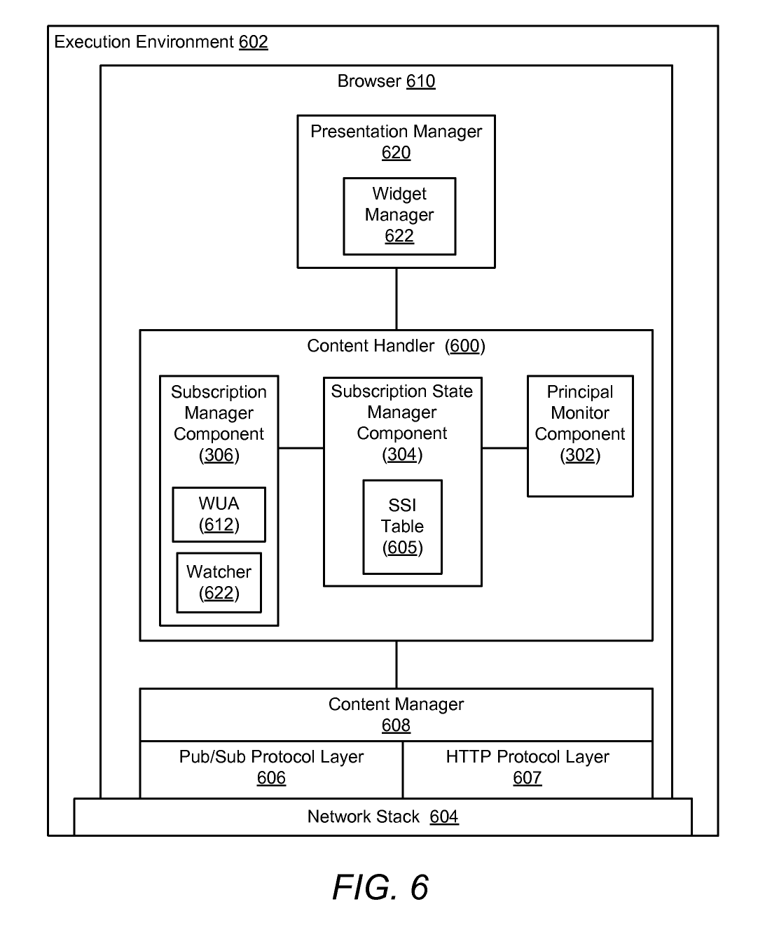

Referring now to FIG. 2, a flow diagram is presented illustrating a method for changing a state of a subscription to a tuple according to an exemplary embodiment. FIGS. 3, 4, 5 and 6 are block diagrams illustrating systems for changing a state of a subscription to a tuple according to embodiments of the subject matter described herein. In particular, FIG. 3 illustrates an arrangement of components configured to change a state of a subscription to a tuple, while FIG. 4, FIG. 5 and FIG. 6 illustrate the components of FIG. 3 and/or their analogs adapted for operation in an execution environment provided by nodes for changing a state of a subscription to a tuple. The method illustrated in FIG. 2 can be carried out by, for example, by at least some of the components in each of the exemplary arrangements of components illustrated in FIGS. 3, 4, 5 and 6. Furthermore, the arrangement of components in FIG. 4, FIG. 5, and FIG. 6 may be implemented by some or all of the components of the hardware device 100 of FIG. 1.

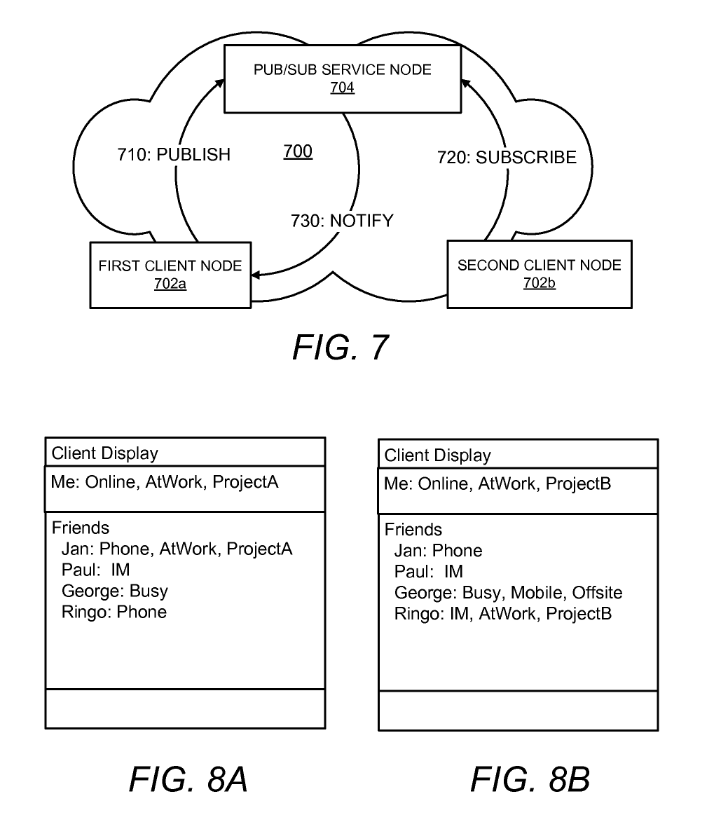

FIG. 3 illustrates components that are configured to operate within an execution environment hosted by a node and/or multiple nodes, as in a distributed execution environment. For example, in FIG. 7, which illustrates a plurality of nodes communicatively coupled to one another via a network 700, such as the Internet, client nodes 702a, 702b, and a pub/sub service node 704 can be configured to provide respective execution environments configured to support the operation of the components illustrated in FIG. 3 and/or their analogs. Exemplary nodes can include desktop computers, servers, networking nodes, notebook computers, PDAs, mobile phones, digital image capture devices, and the like.

According to an embodiment, a pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

By way of example, aspects of an embodiment described here can employ a presence protocol as the pub/sub communications protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence,” each of which are published and owned by the Internet Society and are hereby incorporated by reference in their entirety. A pub/sub protocol, as defined herein, includes any protocol meeting the requirements for a presence protocol as specified in RFC 2779 with the exception that there are no requirements for the content of a pub/sub tuple. That is, a pub/sub tuple is not required to support any particular content, such as status and contact means, as required by RFC 2779 for a presence protocol. Publish and notify messages identify the updated tuple and thus identify the publishing principal. Subscribe messages identify the subscriber.

Generally speaking, one or more service nodes, e.g., node 704, are used to provide pub/sub services. The function of a service node, however, can be incorporated, either in whole or in part, into other entities. For example, the presence service model can be used. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

Users of the presence service are referred to, in the presence model described in RFC 2778, as principals. Typically, a principal is a person or group that exists outside of the presence model. A principal can also be a software component, a hardware component, or other resource capable of being represented by the presence service. A principal can interact with or otherwise be represented by the presence system through a “presence user agent” (PUA) or a “watcher user agent” (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

As mentioned above, a pub/sub service typically stores and organizes published information into tuples. A tuple can represent any element used to store the published information associated with a resource, e.g., a publisher/principal. The published information may include general contact information for the network resource, such as a name, a telephone number, an email address, a postal address, and IP addresses or uniform resource locators (URLs) associated with the resource, and the like, as well as other data or content. As used here, the tuple can also be a representation that maps field names to certain values to indicate that an entity or object (e.g., the principal) includes certain components, information, and/or perhaps has certain properties.

Illustrated in FIG. 4 is a pub/sub service 400 including the components illustrated in FIG. 3 adapted for operating in an execution environment 402. The execution environment 402, or an analog, can be provided by a node such as the pub/sub service node 704. The pub/sub service 400 can include a data store 416 for storing tuples and other data objects. In one embodiment, the tuples can be presence tuples that include a status element corresponding to a principal's status, and the pub/sub service 400 can be a presence service. The pub/sub service 400 can be configured to receive and send information from and to client nodes 702a, 702b via the network 700 using a pub/sub communications protocol, such as a presence protocol. The network 700 may be a Local Area Network (LAN) and/or a Wide Area Network (WAN) including the Internet.

FIG. 5 and FIG. 6 illustrate an application 500 and a content handler 600 in a browser 610, respectively, including the components illustrated in FIG. 3 adapted for operating in an execution environment 502, 602. As mentioned above, the execution environment 502, 602, or an analog, can be provided by a node such as the client node 702a, 702b. The application 500 or browser 610 operating in the client node 702a, 702b can be configured to receive and send information from and to other client nodes 702a, 702b and the pub/sub service node 704 via the network 700 using a pub/sub communications protocol, such as a presence protocol.

With reference to FIG. 2, in block 200, a tuple state change in a first principal's tuple information from a previous state to a current state is detected. The previous state and the current state each indicate that the first principal is actively subscribed to a tuple of a second principal. According to an embodiment, a system for changing a state of a subscription to a tuple includes means for detecting a tuple state change in a first principal's tuple information from a previous state to a current state. For example, FIG. 3 illustrates a principal monitor component 302 configured to detect a tuple state change in a first principal's tuple information from a previous state to a current state, the previous state and the current state each indicating that the first principal is actively subscribed to a tuple of a second principal.

In an embodiment, the principal monitor component 302 can be configured to receive tuple information for updating the first principal's tuple from a previous state to a current state. In both the previous state and the current state, the first principal maintains an active subscription to the tuple of the second principal. Accordingly, at a minimum, the first principal has an active session with a pub/sub service managing subscriptions to tuples, including that of the second principal, during the previous state and the current state of the first principal's tuple information.

In response to receiving the tuple information, the principal monitor component 302 can be configured to detect the tuple state change prior to, during, and/or in response to, an actual update of the first principal's tuple information. A tuple state change can be any change to the tuple information of the first principal, or, in another embodiment, a tuple state change can be defined by a criteria. The principal monitor component 302 can be configured, in an embodiment, to detect the tuple state change by receiving tuple information for updating the first principal's tuple, and, when required, determining whether the received tuple information satisfies the criteria defining the tuple state change.

For example, a criteria defining a tuple state change can specify a distance beyond which a change in location tuple information must be in order to qualify as a tuple state change. Accordingly, when updated location information is received that indicates a change in location, and the distance between the new location and the previous location is beyond the specified distance, the principal monitor component 302 can determine that the change in location information satisfies the criteria, and can indicate that a tuple state change has been detected.

In an embodiment, the principal monitor component 302 can be adapted for operation in a pub/sub service 400, such as, for example, a presence service, operating in an execution environment 402. The principal monitor component 302 can be configured to receive tuple information, for updating the first principal's tuple, in a message, e.g., a PUBLISH command 710, from a node representing the first principal, such as the first client node 702a, via the network 700. The network 700 can support any protocol compatible with a configuration of the pub/sub service 400 and/or other components hosted by a node including a pub/sub service 400. For example, a suitable protocol can provide for sending the tuple information in a request in a request/response communication, in any messaging pattern supported by a pub/sub protocol, and/or in an asynchronous, unsolicited message.

According to an embodiment, the message can be transmitted over the network 700 and received by a network stack 404 in the execution environment 402. At least a portion of the message can be formatted according to a pub/sub protocol, such as a presence protocol. The network stack 404 can be configured to provide at least the pub/sub formatted portion of the message to a pub/sub protocol layer 406, which in turn can pass the message to a message router component 408.

The message router component 408 can be configured to route the received message based on, for example, a message type detected in, and/or a schema supported by, the received information. For example, when the tuple information is included in a PUBLISH command 710, such as that sent by the first client node 702a, the message router 408 can be configured to route the message to a publication handler component 410 for updating the first principal's tuple. In an embodiment, in addition to being configured to update the tuple of the first principal, the publication handler component 410 can be configured to route the tuple information to the principal monitor component 302, which is configured to determine whether a tuple state change is detected.

In another embodiment, the principal monitor component 302 can be configured to detect an update to the tuple of the first principal. In response to detecting the updated tuple, the principal monitor component 302 can be configured to detect a tuple state change based on the updated tuple information in the tuple. Alternatively or additionally, the tuple information can be received in a message not compatible with a pub/sub protocol. For example, the message can be formatted specifically for exchanging the tuple information and can be received via a TCP (Transmission Control Protocol) or UDP (User Datagram Protocol) protocol layer supported by the network stack 404. The tuple information can be received in other protocols including HTTP (HyperText Transfer Protocol) and derivatives of HTTP such as SOAP (Simple Object Access Protocol), a management protocol such as SNMP (Simple Network Management Protocol), a LAN (local area network) protocol such as NetBIOS (Network Basic Input/Output System), and/or a link layer protocol such as IEEE 802.3 or 802.11. In another embodiment, the tuple information can be received from a user via a user interface. Still further, the tuple information can be received from a data storage device, for example, as configuration data for the pub/sub service 400.

In another embodiment, the principal monitor component 302 can be adapted for operation in a pub/sub portion of an application 500, such as an instant messaging (IM) or a voice over IP (VOIP) application, and/or an inventory management, a network management, and other business application operating in an execution environment 502. Alternatively or additionally, the principal monitor component 302 can be adapted for operation in a content handler component 600 of a browser 610 operating in an execution environment 602. In an embodiment, the client node 702a, 702b can be configured to provide the execution environment 502, 602 suitable for supporting the application 500 and the browser 610, respectively.

In the application 500, the principal monitor component 302 can be configured to receive tuple information for updating the first principal's tuple from various sources. For example, the tuple information can be received from a user via a user interface, and/or from the application itself. For example, the application 500 can be an inventory application and the first principal can be a record maintaining information about a type of cable for sale. The principal monitor component 302 in the inventory application 500 can receive tuple information, via the network 700 or from a user, whenever a cable is added or removed from inventory. Alternatively, when a change in inventory of any of various devices that require a cable of the particular type is identified, the inventory application 500 can be configured to determine the change in inventory of cables. The change in cable inventory can be provided to, determined by, or otherwise detected by the principal monitor component 302, which can be in or external to the inventory application 500. The principal representing the cable for sale can have an active subscription to one or more tuples representing one or more respective cable suppliers.

In the browser 610, the content handler 600 can be configured to process a particular type, e.g., MIME type, of content. Accordingly, while a single content handler 600 is illustrated in FIG. 6, the browser 610 can support and include more than one content handler 600 to process different data types. For example, a video stream content handler can be provided and configured to process a particular type of video data corresponding to a video stream, while an image content handler can also be provided and configured to process image data formats identifiable by MIME type. Additionally or alternatively, a content handler 600 can be configured to process more than one type of markup language based data.

In an embodiment, the browser 610 can include one or more content handlers 600 each representing one or more principals including a user of the browser 610, a component or plugin of the browser 610, or any resource the browser 610 is configured to monitor. The principal monitor component 302 in the content handler 600 can be configured to receive tuple information for updating the corresponding principal's tuple in content received from and/or sent to the network 700. In an embodiment, content can be received and sent via a protocol layer of the network stack 604, or via an application protocol layer, or other higher protocol layer, as illustrated by an exemplary HTTP protocol layer 607 among many possible standard and proprietary protocol layers. The content handler 600 can receive the content via a content manager component 608 in an embodiment. The content manager component 608 can access at least a portion of the content, and parse it into elements of the type(s) supported by the content handler 600.

Additionally, tuple information can be received via a presentation manager 620 of the browser 610. The presentation manager 620 can be configured to interoperate with a presentation subsystem (not shown) in the execution environment 602 to present a graphical user interface (GUI) for the browser 610. Input, such as user input, can be received from an input device (not shown) by an input subsystem of the execution environment 602. The input can be received in correspondence with a widget presented by a widget manager 622 as part of the browser GUI by the presentation subsystem interoperating with a display device (not shown) as directed by the presentation manager 620 directed by one or more content handlers 600.

As stated above, the content handler 600 can represent a principal whose tuple state is to be monitored. For example, a web page can be a monitored principal whose tuple state is monitored by a principal monitor component 302. A change in tuple state can be detected in response to an input received for the page from a user, a component in the execution environment 602, or from a remote source. For example, the received input can correspond to a URL entered into a location bar widget of the browser GUI or a link presented in the web page in a page widget or tab widget of the browser GUI. An indication of the input can be provided to the presentation subsystem, which is configured to determine an application or other component to receive the input based on the correspondence between the input and the state of the presentation. The presentation subsystem can determine that the input information is to be provided to the presentation manager 620 of the browser 610. The presentation manager 620 can be configured to determine one or more components configured to process the input such as the content handler 600 representing the web page.

In another example, the principal can be a transaction processed at least in part via the browser 610 and monitored by a principal monitor component 302 in a content handler 600. A tuple state change can include a status change in the transaction, or change, e.g., add, delete, update, in any tuple information included in the processing of the transaction. For instance, in a sales transaction, the state of the transaction, as represented by a tuple, can indicate an item in a shopping cart, e.g., the transaction state is “Shopping,” with a sub-state indicated by the number of units of the item in the cart. The transaction principal can have an active subscription to a tuple representing the item, including inventory and pricing information, where the subscription state corresponds to the number of units of the item in the cart. A tuple state change can be detected when the number of units of the item is changed from a previous state to a current state. The change can be a result of user input or a result of a change in the number of units in stock, for example.

In addition, the shopping cart can be a principal represented by a tuple, e.g., a sub-tuple of the transaction tuple. The shopping cart can have a subscription to a tuple representing a budget as a second principal, where the budget is an overall budget for the shopper. The tuple state of the shopping cart can be indicated by the contents of the cart. The subscription state to the user's budget tuple can include subscriptions to budget categories associated with items in the cart. When a new item is added to the cart, the principal monitor component 302 can detect a tuple state change. In an embodiment, the principal monitor component 302 can operate in the scripts of web pages associated with the cart as provided by a service provider.

Referring again to FIG. 2, once the tuple state change is detected, in block 202, an association between the detected tuple state change and subscription state information is identified. In an embodiment, the subscription state information is based on at least one of the previous state and the current state. According to an embodiment, a system for changing a state of a subscription to a tuple includes means for identifying an association between the detected tuple state change and subscription state information. For example, FIG. 3 includes a subscription state manager (SSM) component 304 configured to identify an association between the detected tuple state change and subscription state information, where the subscription state information is based on at least one of the previous state and the current state.

According to an embodiment, when the tuple state change is detected, the principal monitor component 302 can invoke the SSM component 304 to identify subscription state information associated with the detected tuple state change. The SSM component 304, in an embodiment, can include a subscription state information (SSI) table 405, 505, 605 that provides associations between tuple state changes and subscription state information. For example, the SSI table 405, 505, 605 can include a plurality of records each representing an association between a tuple state change and subscription state information. In an embodiment, the principal monitor component 302 can provide the detected tuple state change to the SSM component 304, which can be configured to perform a table lookup based on the detected tuple state change to identify the association.

Alternatively or additionally, the association can be provided via a formula or method the SSM component 304 is configured to perform or provide for performing by invoking another component. The other component can be determined based on the detected tuple state change and/or the detected tuple state change can be provided to the other component.

Referring again to FIG. 2, in block 204, once the association between the detected tuple state change and subscription state information is identified, a next state of an active subscription to the tuple of the second principal is determined based on the subscription state information. According to an embodiment, a system for changing a state of a subscription to a tuple includes means for determining a next state of an active subscription to the tuple of the second principal. For example, the subscription state manager (SSM) component 304 can be configured to determine a next state of an active subscription to the tuple of the second principal based on the subscription state information.

According to an embodiment, subscription state information is based on the previous and/or the current state of the tuple information of the first principal, and indicates a next subscription state corresponding to an active subscription to a tuple associated with a second principal. For example, referring again to the inventory application 500 that monitors information about a cable, the principal representing the cable can have an active subscription to a tuple representing a cable supplier. While the number of cables in stock remains above a given threshold, the active subscription state (“In Stock”) subscribes only to a communication status of the supplier. When the number of cables falls below the threshold, however, a tuple state change can be detected, e.g., “Stock Low” or “Out of Stock,” and the SSM component 304 can be invoked to identify the association and to determine the next active subscription state for the active subscription to the supplier's tuple. In this case, the next subscription state can be a “supplier readiness” state, defined below, as opposed to the “supplier communication status” state.

In the case of the browser 610 processing a transaction monitored by a principal monitor component 302 in a content handler 600, the transaction principal can have an active subscription to a tuple representing the item, including inventory and pricing information. In this example, the subscription state can correspond to an active subscription that provides information from a pricing element based on the number of units in the cart. For example, if the number of units of the item is five (5) or less, the “5 or less” subscription state corresponds to an active subscription that provides pricing from a base price element. When a change in the number of units constitutes a tuple state change, the SSM component 304 can be invoked to identify the association and to determine the next subscription state for the active subscription to the tuple representing the item. In this case, the next subscription state can include a subscription to a different unit price based on the changed number of units for the item in the shopping cart.

Alternatively or additionally, the transaction principal can be actively subscribed to a tuple of a supplier and the subscription state can be monitoring the availability of the supplier. If the changed number of items exceeds the number available, the SSM component 304 can determine a next state of the active subscription that includes a subscription to information indicating the number and timeframe of availability of additional units of the item from the supplier. In another example, the shopping cart is a principal represented by a tuple, e.g., a sub-tuple of the transaction tuple, and the shopping cart is subscribed to the tuple representing the overall budget for the shopper. When a new item is added to the shopping cart and a tuple state change is detected, the SSM component 304 can determine a next state of the active subscription that includes a subscription to budget information for a category associated with the new item.

Referring again to FIG. 2, in block 206, once the next state of the active subscription is determined, the process provides for changing a first state of the active subscription to the tuple of the second principal to the determined next state. According to an embodiment, a system for changing a state of a subscription to a tuple includes means for providing for changing a first state of the active subscription to the tuple of the second principal to the determined next state. For example, FIG. 3 includes a subscription manager component 306 configured to provide for changing a first state of the active subscription to the tuple of the second principal to the determined next state.

According to an embodiment, the subscription manager component 306 can be invoked when the SSM component 304 determines the next active subscription state. Once invoked, the subscription manager component 306 can be configured, in an embodiment, to receive or otherwise determine a tuple identifier associated with the next subscription state and to provide for changing the subscription state from a first state to the next state.

For example, in the application 500 and in the browser 610, the subscription manager component 306 can receive the next subscription state information from the SSM component 304 and can be configured to send a subscription message 720 to a pub/sub service node 704 maintaining the tuple of the second principal. In an embodiment, the subscription message is for changing the first principal's active subscription to the tuple of the second principal from the first state to the next state. The pub/sub service node 704 can be configured to receive the subscription message 720 and to change the first principal's subscription to the tuple of the second principal from the first state to the next state.

According to an embodiment, the subscription manager component 306 can include a WUA 512, 612 configured to generate a SUBSCRIBE message that identifies at least one of the tuple of the second principal, the next subscription state, and the first principal. For example, in an embodiment, the SUBSCRIBE message can include a subscription state identifier that identifies one or more elements of the monitored tuple to be included in the subscription for the next state. The association between the identifier and the elements to be included can be retained by the receiver of the SUBSCRIBE message or another service. Alternatively, the SUBSCRIBE message can identify tuple elements included in the next subscription state or the changes in elements to include or drop from the subscription to transition from the first state to the next state.

The SUBSCRIBE message can be formatted according to a pub/sub protocol, such as a presence protocol. Once the message is generated, the message can be sent to the pub/sub service node 704 maintaining the tuple of the second principal via the network 700 according to a suitable communication protocol, of which a large number exist or can be defined. For example, the subscription manager component 306 can include a watcher 522, 622 configured to support communication via a pub/sub protocol such as a presence protocol. The watcher 522, 622 can send the message 720 according to the configuration of the application 500 or browser 610. The message can be provided to a pub/sub protocol layer 506, 606, which can be configured to package the message for sending. Such packaging can include reformatting the message, breaking the message into packets, including at least a portion of the message along with at least a portion of another message to be transmitted together, and/or adding additional information such as a header or trailer as specified by the protocol used.

In another embodiment, in the pub/sub service 400, the subscription manager component 306 can receive the next subscription state information from the SSM component 304 and can be configured to update a subscription list associated with the tuple of the second principal to change the first principal's subscription from the first state to the next state. In an embodiment, the subscription manager component 306 can be configured to provide for generating a notification corresponding to the next subscription state to be sent to a watcher representing the first principal represented by a client node 702a, 702b. For example, the subscription manager component 306 can be configured to interoperate with a notification handler component 412 for generating a notification including tuple information corresponding to the next subscription state in a notification message. The notification message can be provided to the message router component 408 by the notification handler component 412 for sending to the first principal represented by the first client node 702a. For example, the message router component 408 can be configured to interoperate with the pub/sub protocol layer 406 for sending the tuple information corresponding to the next subscription state to the watcher representing the first principal, in a NOTIFY message 730 formatted according to the configured pub/sub protocol via the network protocol stack 404 and the network 700.

FIG. 8A and FIG. 8B illustrate exemplary client displays provided by the client node 702a, 702b. In an embodiment, the displays can be provided by the browser 610 or the application 500. In FIG. 8A, the tuple information of the first principal indicates she is “Online,” “AtWork,” and working on “ProjectA.” The first principal has active subscriptions to tuples representing principals on the first principal's friends list. In FIG. 8B, the tuple information of the first principal indicates that she is now working on “ProjectB.” In this example, the change from “ProjectA” to “ProjectB” constitutes a tuple state change and therefore, an association between such a change and subscription state information is identified, and a next subscription state is determined based on the subscription state information. For example, the subscription state information can indicate that the next subscription state to Jan's tuple is to remove status elements associated with Work Status and Work Topic. When the subscription state to Jan's tuple is changed, the first principal will receive tuple information corresponding to the changed subscription. Accordingly, in FIG. 8B, the tuple information of Jan no longer includes his work status and his work topic.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A system for changing a state of a subscription to a tuple, the system comprising system components including:
a principal monitor component configured to detect a tuple state change in a first principal's tuple information from a previous state to a current state, the previous state and the current state each indicating that the first principal is actively subscribed to a tuple of a second principal;
a subscription state manager component configured to identify an association between the detected tuple state change and subscription state information, wherein the subscription state information is based on at least one of the previous state and the current state, and to determine a next state of an active subscription to the tuple of the second principal based on the subscription state information; and
a subscription manager component configured to provide for changing a first state of the active subscription to the tuple of the second principal to the determined next state,
wherein at least one of the system components includes at least one electronic hardware component.

2. The system of claim 1 wherein the principal monitor component is configured to detect the tuple state change by receiving tuple information for updating the first principal's tuple from at least one of a message sent from a node representing the first principal, the message received via a network, a user via a user interface, an application, and configuration data in a local data store.

3. The system of claim 2 wherein the message including the tuple information for updating the first principal's tuple is formatted according to a publish/subscribe protocol.

4. The system of claim 3 wherein the message is a publish command.

5. The system of claim 3 wherein the publish/subscribe protocol is a presence protocol.

6. The system of claim 1 wherein the tuple state change is defined by a criteria and wherein the principal monitor component is configured to detect the tuple state change by receiving tuple information for updating the first principal's tuple, and determining whether the received tuple information satisfies the criteria defining the tuple state change.

7. The system of claim 1 wherein the association between the detected tuple state change and subscription state information is provided in a table, and wherein the subscription state manager component is configured to perform a table lookup based on the detected tuple state change to identify the association.

8. The system of claim 1 wherein the subscription manager component is configured to send a subscription message to a publish/subscribe service maintaining the tuple of the second principal, the subscription message for changing the first principal's active subscription to the tuple of the second principal from the first state to the next state.

9. The system of claim 1 wherein the subscription manager component is configured to update a subscription list associated with the tuple of the second principal to change the first principal's subscription from the first state to the next state.

10. A system for changing a state of a subscription to a tuple, the system comprising:
means for detecting a tuple state change in a first principal's tuple information from a previous state to a current state, the previous state and the current state each indicating that the first principal is actively subscribed to a tuple of a second principal;
means for identifying an association between the detected tuple state change and subscription state information, wherein the subscription state information is based on at least one of the previous state and the current state;
means for determining a next state of an active subscription to the tuple of the second principal based on the subscription state information; and
means for providing for changing a first state of the active subscription to the tuple of the second principal to the determined next state,
wherein at least one of the means includes at least one electronic hardware component.

11. A method for changing a state of a subscription to a tuple, the method comprising:
detecting a tuple state change in a first principal's tuple information from a previous state to a current state, the previous state and the current state each indicating that the first principal is actively subscribed to a tuple of a second principal;
identifying an association between the detected tuple state change and subscription state information, wherein the subscription state information is based on at least one of the previous state and the current state;
determining a next state of an active subscription to the tuple of the second principal based on the subscription state information; and
providing for changing a first state of the active subscription to the tuple of the second principal to the determined next state,
wherein at least one of the preceding actions is performed on at least one electronic hardware component.

12. The method of claim 11 wherein detecting the tuple state change includes receiving tuple information for updating the first principal's tuple from at least one of a message sent from a node representing the first principal, the message received via a network, a user via a user interface, an application, and configuration data in a local data store.

13. The method of claim 12 wherein the message including the tuple information for updating the first principal's tuple is formatted according to a publish/subscribe protocol.

14. The method of claim 13 wherein the message is a publish command.

15. The method of claim 13 wherein the publish/subscribe protocol is a presence protocol.

16. The method of claim 11 wherein the tuple state change is defined by a criteria and wherein detecting the tuple state change includes receiving tuple information for updating the first principal's tuple, and determining whether the received tuple information satisfies the criteria defining the tuple state change.

17. The method of claim 11 wherein the association between the detected tuple state change and subscription state information is provided in a table, and wherein identifying the association includes performing a table lookup based on the detected tuple state change.

18. The method of claim 11 wherein providing for changing the first state of the active subscription to the tuple of the second principal includes sending a subscription message to a publish/subscribe service maintaining the tuple of the second principal, the subscription message for changing the first principal's active subscription to the tuple of the second principal from the first state to the next state.

19. The method of claim 11 wherein providing for changing the first state of the active subscription to the tuple of the second principal includes updating a subscription list associated with the tuple of the second principal to change the first principal's subscription from the first state to the next state.

20. A computer readable medium storing a computer program, executable by a machine, for changing a state of a subscription to a tuple, the computer program comprising executable instructions for:
detecting a tuple state change in a first principal's tuple information from a previous state to a current state, the previous state and the current state each indicating that the first principal is actively subscribed to a tuple of a second principal;
identifying an association between the detected tuple state change and subscription state information, wherein the subscription state information is based on at least one of the previous state and the current state;
determining a next state of an active subscription to the tuple of the second principal based on the subscription state information; and
providing for changing a first state of the active subscription to the tuple of the second principal to the determined next state.
